(19) United States
(12) Patent Application Publication
(10) Pub. No.: US 2006/0129856 A1
(43) Pub. Date: Jun. 15, 2006

(54) System and method for expansion card power limiting

(76) Inventors: Kevin Keith Main, Plano, TX (US); James J. Walsh, Dallas, TX (US)

Correspondence Address: TEXAS INSTRUMENTS INCORPORATED, P O BOX 655474, M/S 3999, DALLAS, TX, 75265, US

(21) Appl. No.: 11/009,491

(22) Filed: Dec. 10, 2004

(51) Int. Cl. G06F 1/26

(52) U.S. Cl. 713/320

(57) ABSTRACT

System and method for limiting power consumption in add-in expansion cards. A preferred embodiment comprises retrieving power consumption information for the add-in card, receiving power limit information for the expansion bus, determining if the add-in card is over power, and reducing the add-in card's power consumption if the add-in card is over power. The reducing can involve disabling the add-in card completely or disabling certain functions of the add-in card based upon an amount that the add-in card is over power.

### TECHNICAL FIELD

The present invention relates generally to a method for digital computing, and more particularly to a system and a method for limiting power consumption in add-in expansion cards.

### BACKGROUND

General purpose computers are built with a certain feature set that is intended to provide a minimum level of performance for a majority of customers. For many customers, this feature set is insufficient for their needs and desires. The use of add-in expansion cards (add-in card) permits the user to add extra functionality to their computer that was not available in the computer when purchased. Additionally, the use of add-in expansion cards can allow the user to upgrade to a higher performance computer. For example, the user can upgrade the video card and/or sound card that may be built into their computer. Alternatively, the user can install additional hard drive controllers to increase the amount of storage that their computer is capable of holding.

The add-in cards can be attached to the computer via an expansion bus. The expansion bus provides a high-speed communications bus to transfer data between the computer's CPU, memory, storage and the add-in card. A commonly used expansion bus in modern computers is the peripheral connection interface (PCI) bus which has been extended functionally into the PCI Express bus. The PCI bus and the PCI Express bus provide compatible cards with a reliable communications bus with good data transfer rates. Both the PCI and PCI Express buses provide a certain amount of power to each add-in card installed. The PCI Express technical standard provides an optional mechanism for reporting a maximum amount of power that can be provided to an add-in card. If an add-in card should require more power than the bus can provide, then the add-in card may not operate or may operate in an erroneous fashion, and it is up to the designer of the add-in card to make sure that the add-in card's power consumption meets the specifications or provide an alternate method for obtaining the needed power.

In the past, when an add-in card required more power than what was provided by the expansion bus, one way to provide the needed power was to connect a power supply lead from the computer's power supply directly to the add-in card.

One disadvantage of the prior art is that in some situations, if the power supply of the computer is at its limit with regard to the amount of power it can provide, then the power supply would not be able to provide the power needed by the add-in card and the add-in card would not be able to operate properly. Furthermore, the power supply may not have a sufficient number of leads to connect to the add-in card. This can lead to the need to use additional leads, which may be a problem if the user does not have additional leads.

### SUMMARY OF THE INVENTION

These and other problems are generally solved or circumvented, and technical advantages are generally achieved, by preferred embodiments of the present invention which provides a method for limiting power consumption on add-in expansion cards.

In accordance with a preferred embodiment of the present invention, a method reconciling an add-in card's power requirements with a power limited expansion bus is provided. The method comprises retrieving power consumption information for the add-in card and receiving power limit information for the expansion bus. The method further comprises determining if the add-in card is over power and reducing the add-in card's power consumption if the add-in card is over power.

In accordance with another preferred embodiment of the present invention, a method for reducing power consumption in an add-in card is provided. The method comprises determining if the add-in card is over power and reducing power consumption in a subset of integrated circuits in the add-in card if the add-in card is over power, wherein the subset of integrated circuits is selected based upon a function of the add-in card that is selected for disablement.

In accordance with another preferred embodiment of the present invention, an add-in card is provided. The add-in card comprises a controller coupled to an expansion bus in a computer and a plurality of integrated circuits coupled to the controller. The plurality of integrated circuits is configured to perform an intended function of the add-in card and each integrated circuit is coupled to the controller by a power limit signal line that is used to disable the operation of the integrated circuit to reduce power consumption in the add-in card.

An advantage of a preferred embodiment of the present invention is that it can be possible for add-in cards with power requirements that exceed the power capabilities of the expansion bus to adjust its performance level to reduce its power consumption so that the add-in card can still operate, although at a potentially lower performance level.

A further advantage of a preferred embodiment of the present invention is that the present invention can be implemented without needing any changes to existing expansion bus and computer hardware and/or software. This can greatly reduce the cost of implementing the present invention.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a computer;

FIG. 2 is a diagram of an add-in expansion card;

FIG. 3 is a diagram of a sequence of events for limiting power consumption in an add-in card of an expansion bus with limited power capability, according to a preferred embodiment of the present invention;

FIGS. 4a through 4d are diagrams of ways to reduce power consumption in an add-in card, according to a preferred embodiment of the present invention;

FIGS. 5a through 5c are diagrams of exemplary add-in expansion cards, wherein the add-in cards have the capability to alter their function based upon their power consumption needs and a limit on the amount of power the expansion bus is capable of providing, according to a preferred embodiment of the present invention; and

FIG. 6 is a diagram of an algorithm for regulating power consumption of an add-in card based on a maximum power provided by an expansion bus slot, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a computer add-in card for the PCI Express compliant expansion bus. The invention may also be applied, however, to add-in cards for other expansion buses wherein there is a limit on the amount of power that can be supplied by the expansion bus and the add-in card exceeds the power limit, but there is no requirement in the specifications as to how to respond to such a situation.

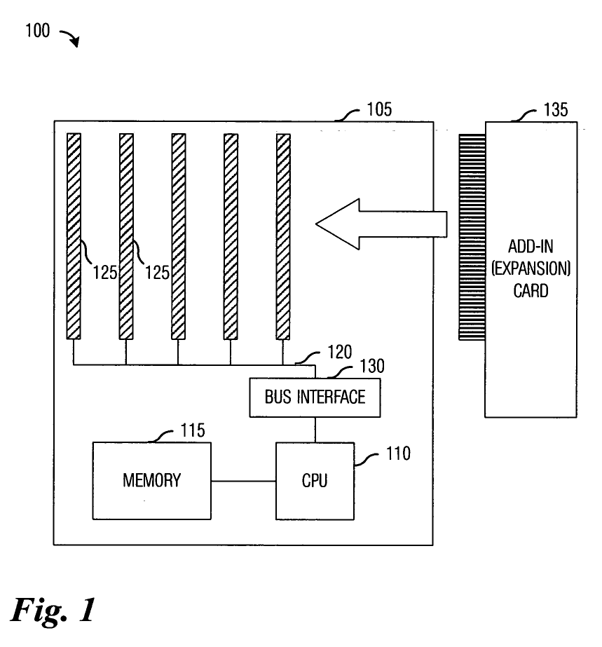

With reference now to FIG. 1, there is shown a diagram of a computer 100. The diagram shown in FIG. 1 illustrates a high-level view of the computer 100, wherein major components of the computer's main board 105 are shown. Note that circuitry such as glue logic, power supplies, and other components of the computer 100 are not shown. Major components of the computer 100 located on the main board 105 can include a central processing unit(s) (CPU) 110, memory 115: (including both solid-state memory and magnetic memory), an expansion bus 120, expansion bus slots 125, and a bus interface 130. As discussed previously, the expansion bus can provide a high data-rate communications bus for use in adding additional functionality to the computer 100 while the expansion bus slots 125 are slots wherein expansion cards 135 (or add-in cards) can be inserted to make electrical contact with the expansion bus 120. The bus interface 130 can serve as a bridge between the expansion bus 120 and expansion cards 135 on the expansion bus 120 and the CPU 110. The bus interface 130 can translate communications between the expansion cards 135 and the CPU 110 into signals that can be understood by both as well as perform necessary handshaking operations to ensure the proper operation of expansion cards 135 inserted into the expansion bus slots 125.

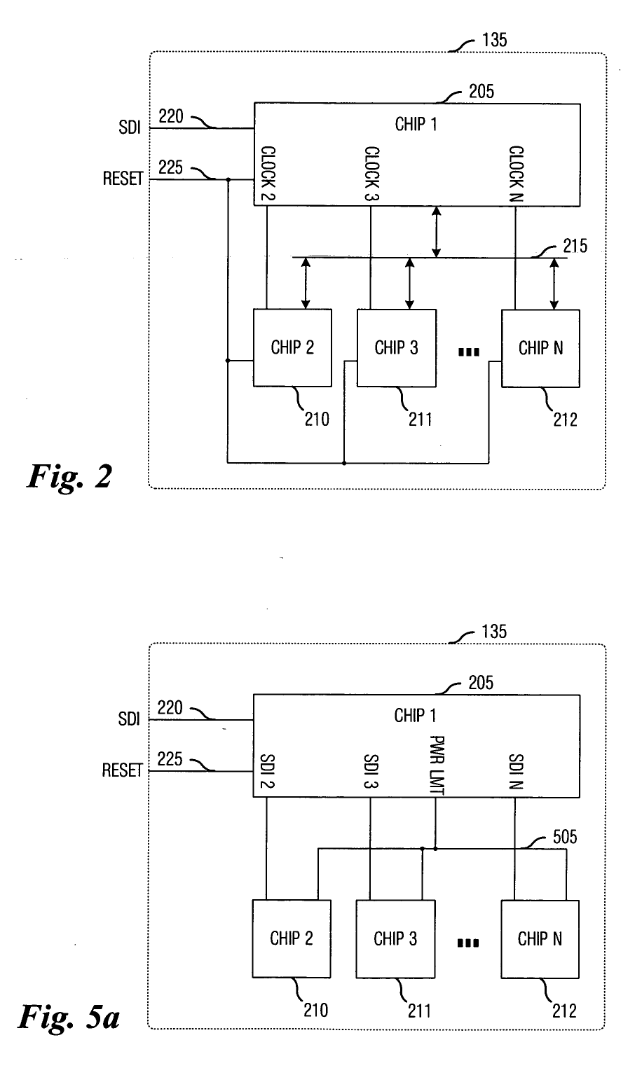

With reference now to FIG. 2, there is shown a diagram illustrating an add-in expansion card. The diagram shown in FIG. 2 illustrates a high-level view of the add-in card 135. Note that the diagram displays the major components of the add-in card 135, not all of the components of the add-in card 135. The add-in card 135 shown in FIG. 2 can be representative of a generic PCI Express add-in card. The diagram shown in FIG. 2 can be an add-in card functioning as a video card, sound card, hard disk controller, and so forth.

The add-in card 135 includes an interface integrated circuit (“chip”), referred to as “Chip 1” 205. A purpose of “Chip 1” 205 can be to control the power-on sequence of other chips in the add-in card 135, serve as a communications bridge between the other chips in the add-in card 135 and the expansion bus, determine which of the other chips in the add-in card 135 to turn on, and so forth. The other chips in the add-in card 135, such as “Chip 2” 210, “Chip 3” 211, and “Chip N” 212, can be chips required to provide the desired functionality of the add-in card 135. Note that “Chip 2” 210, “Chip 3” 211, and “Chip N” 212, along with other chips in the add-in card 135 that are not shown can be collectively referred to as the other chips in the add-in card 135. For example, if the add-in card 135 is a video card, then the other chips in the add-in card 135 may be a video codec, a video dac, memory, and so on. The other chips in the add-in card 135 can communicate and share information with each other and “Chip 1” 205 by a communications bus 215.

The “Chip 1” 205 can also provide clock signals to each of the other chips in the add-in card 135. The clock signals provided by the “Chip 1” 205 may be individual, wherein each of the other chips in the add-in card 135 can potentially receive a separate clock signal (as shown in FIG. 2) or some of the clock signals may be shared, wherein more than one chip may receive the same clock signal (i.e., a single clock signal line is connected to more than one chip).

Also shown in FIG. 2 are two signal lines, a serial data interface (SDI) signal line 220 and a reset signal line 225. These two signal lines may be part of other signal lines that are provided to the add-in card 135 when it is inserted into an expansion bus slot 125. There may be other signal lines being provided to the add-in card 135, but only these two are being shown to help maintain simplicity of the figure. Note that while shown as a single line, the SDI signal line 220 may be representative of a plurality of signal lines. Additionally, while one of the signal lines shown, the SDI signal line 220, can imply that the add-in card 135 uses a serial data interface, it can be possible to replace the SDI signal line 220 with a parallel data interface without affecting the spirit of the present invention. A purpose of the SDI signal line 220, or some other form of data interface being to provide a way for the add-in card 135 and the computer 100 to exchange information. The reset signal line 225 can be connected to the “Chip 1” 205 and some or all of the chips in the add-in card 135, with an intended purpose of placing the chips to which it is connected into a reset state.

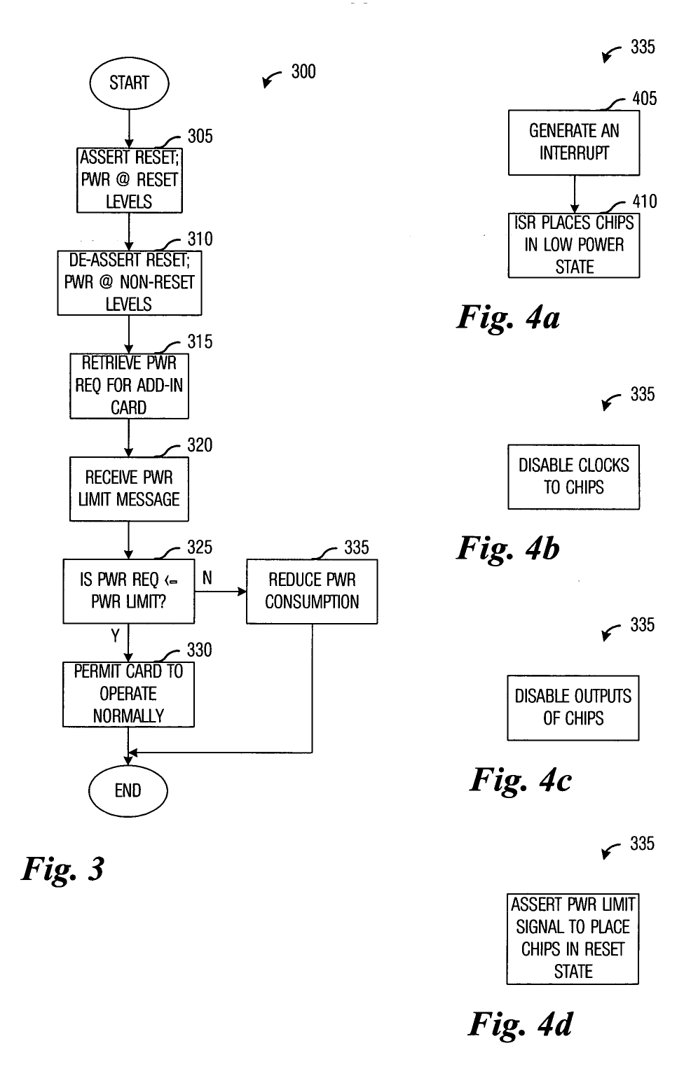

With reference now to FIG. 3, there is shown a flow diagram illustrating a sequence of events 300 for limiting power consumption in an add-in card of an expansion bus with limited power capability, according to a preferred embodiment of the present invention. According to a preferred embodiment of the present invention, the sequence of events 300 can occur on an add-in card, such as the add-in card 135 (FIG. 2), after it has been inserted into an expansion bus slot, such as the expansion bus slot 125 and after the computer 100 has been powered on. The sequence of events 300 may take place on an integrated circuit on the add-in card 135, such as the “Chip 1” 205 (FIG. 2), that can be responsible for the operation and/or power-on sequence of the add-in card 135.

The sequence of events 300 can begin when power is initially provided to the computer 100 or after the computer 100 has been reset. After the power has been applied, a reset signal can be asserted and as long as the reset signal is being asserted, then chips on the add-in card 135 can be kept in a reset state wherein the chips consume a small amount of power since the chips are in the reset state (block 305). After the power has been applied to the computer 100 for a certain amount of time (for example, to permit an initialization of all required initial states and to configure needed circuitry) the reset signal is de-asserted. When the reset signal is de-asserted, the chips in the add-in card 135 are no longer in the reset state and can therefore, begin to consume a larger amount of power (block 310). Note however, that the chips in the add-in card 135 may not be consuming as much power as if they were operating in a full function mode since the computer 100 may have not begun full operation and hence the add-in card 135 may have not begun full operation.

The integrated circuit that is responsible for the operation of the add-in card 135, such as “Chip 1” 205, can then retrieve information regarding the amount of power that the add-in card 135 will require when it is fully operating (block 315). According to a preferred embodiment of the present invention, the information regarding the power requirement of the add-in card 135 can be stored in firmware located in the add-in card 135 or in a memory (likely to be read-only memory (ROM)) that is located near or in the “Chip 1” 205. Alternatively, the information can be stored in a memory location, such as a register, that is a part of the “Chip 1” 205. The power requirement of the add-in card 135 can be determined by the manufacturer through power consumption measurements made during development and manufacture of the add-in card 135 and can be stored on the add-in card 135 during the manufacture of the add-in card 135. Alternatively, the power requirement may be saved in an application driver for the add-in card 135 and can be written to the add-in card 135 or a memory storage during an installation of the add-in card 135.

In addition to retrieving information about the power requirements of the add-in card 135 (block 315), the “Chip 1” 205 may also receive a message from the computer 100 that specifies the maximum power that an expansion bus slot is able to provide (block 320). Note that the amount of power that an expansion bus slot can provide can differ for different computers. The message may be provided by system software of the computer 100, an operating system executing on the computer 100, the computer's firmware, and so forth. The amount of power provided by an expansion bus slot can vary depending on the computer 100 and can be based on factors such as the number of expansion slots available on the computer 100, the size of the power supply of the computer 100, and so forth.

After receiving the message containing information regarding a maximum amount of power that an expansion bus slot can provide (block 320), the “Chip 1” 205 can make a comparison between the power required by the add-in card 135 and the maximum amount of power that can be supplied by an expansion bus slot (block 325). If the power required by the add-in card 135 is less than the maximum amount of power provided by the expansion bus slot, then the add-in card 135 can be permitted to operate in a normal fashion (block 330) and the sequence of events 300 terminates. However, if the power required by the add-in card is greater than the maximum amount of power supplied by the expansion bus slot, then the “Chip 1” 205 must reduce power consumption (block 335), which can include a partial or complete disabling of the add-in card 135, and the sequence of events 300 can terminate.

With reference now to FIGS. 4a through 4d, there are shown diagrams illustrating differing ways that power consumption can be reduced in an add-in card, according to a preferred embodiment of the present invention. The diagrams shown in FIGS. 4a through 4d illustrate several exemplary ways that power consumption can be reduced in an add-in card without requiring modifications to hardware in the computer 100 where the add-in card 135 is installed. Furthermore, some of the solutions do not require any modification to any software or firmware in the computer 100. The diagram shown in FIG. 4a illustrates the use of an interrupt to result in the reduction of power consumption in the add-in card 135. When the “Chip 1” 205 detects that the add-in card 135 requires more power than can be supplied by the expansion bus slot (block 325 (FIG. 3)), referred to as a “subsystem_over_power_condition,” then the “Chip 1” 205 can assert a “power_over” output signal. The assertion of the “power_over” output signal can result in the generation of an interrupt (block 405). The generation of the interrupt will then lead to the execution of an interrupt service routine (ISR) which can be used to place some (or all) other chips in the add-in card 135 into a low power state (block 410). Additionally, the ISR can also configure the other chips in the add-in card 135 so that the other chips will not accept programming from other programs that may lead to the other chips into consuming more power. The ISR can be added to the software and/or firmware of the computer 100 during the installation process of the add-in card 135, for example.

It may be possible to control the degree to which the ISR places some (or all) of the other chips in the add-in card 135 into a low power consumption state whenever the “subsystem_over_power_condition” occurs. When the “subsystem_over_power_condition” occurs, the ISR can simply place the other chips in the add-in card 135 into a low power consumption state without regard to the degree to which the add-in card 135 is over power. When the ISR does not regard the magnitude of the over power, then the ISR can substantially shut down the operation of the add-in card 135. Alternatively, the ISR can consider the degree to which the add-in card 135 is over power and it can shut down a sufficient number of the other chips to ensure that the add-in card 135 is no longer over power, but yet can still provide a limited amount of functionality. For example, if the add-in card 135 is a video graphics card, then the ISR can turn off some of the functionality of the add-in card 135 to help reduce power consumption. If a sufficient functionality is turned off, it may be possible to lower the power consumption of the add-in card 135 to a level where the add-in card 135 is no longer over power. It may be possible for the manufacturer to provide a table that can be stored in a memory in the add-in card 135 that lists the various functions of the add-in card 135 and a net reduction in power consumption when each is turned off. Alternatively, the manufacturer can provide a list of which functions can be turned off to yield a certain power consumption. The ISR can then determine which functions of the add-in card 135 it wishes to turn off or leave on to meet the power limitation of the expansion bus slot.

The diagram shown in FIG. 4b illustrates the use of clock signal disabling to reduce power consumption. When the “Chip 1” 205 detects that the “subsystem_power_over_condition” has occurred, the “Chip 1” 205 can reduce power consumption in the add-in card 135 by disabling clock signals to the other chips in the add-in card 135. When signals are not switching in the other chips in the add-in card 135, power consumption is minimized. Once again, the disabling of the clock signals to the other chips can take place with or without regard to the magnitude of the over power. It can be possible for the “Chip 1” 205 to disable the clock signals to some of the other chips in the add-in card 135 to preserve a certain level of functionality and to drop the power consumption of the add-in card 135 so that the “subsystem_power_over_condition” no longer occurs.

The diagram shown in FIG. 4c illustrates the use of output signal disabling to reduce power consumption. When the “Chip 1” 205 detects that the “subsystem_power_over_condition” has occurred, the “Chip 1” 205 can reduce power consumption by disabling the transmission of output signals between the other chips in the add-in card 135. When the inputs to the other chips in the add-in card 135 are not changing, the other chips can stop processing information, thereby reducing power consumption. Again, the disabling of the output signals between the other chips can take place with or without regard to the magnitude of the over power. It can be possible for the “Chip 1” 205 to disable the output signals between some of the other chips in the add-in card 135 to preserve a certain level of functionality and to drop the power consumption of the add-in card 135 so that the “subsystem_power_over_condition” no longer occurs.

The diagram shown in FIG. 4d illustrates the use of a reset signal to place the other chips in the add-in card 135 into a reset state when the “Chip 1” 205 detects that the “subsystem_power_over_condition” has occurred. Whenever the “Chip 1” 205 detects the occurrence of the “subsystem_power_over_condition” or when the reset signal line 225 (FIG. 2) is asserted, the “Chip 1” 205 can place the other chips in the add-in card 135 into the reset state. As discussed previously, when in the reset state, a chip's power consumption can be drastically lower than when it is in a normal operating state. When the reset signal line 225 is asserted, the “Chip 1” 205 can place all of the other chips in the add-in card 135 in the reset state. However, when the “subsystem_power_over_condition” is detected, the “Chip 1” 205 can place some or all of the other chips in the add-in card 135 into the reset state. As discussed previously, it can be possible for the “Chip 1” 205 to place some of the other chips in the add-in card 135 into the reset state to preserve a certain level of functionality and to drop the power consumption of the add-in card 135 so that the “subsystem_power_over_condition” no longer occurs.

It can be possible to combine some of the power reduction methods shown above. The combination of two or more such methods can further reduce power consumption in the add-in card 135. For example, the technique shown in FIG. 4b (clock disabling) can be readily combined with the technique shown in FIG. 4c (output disabling).

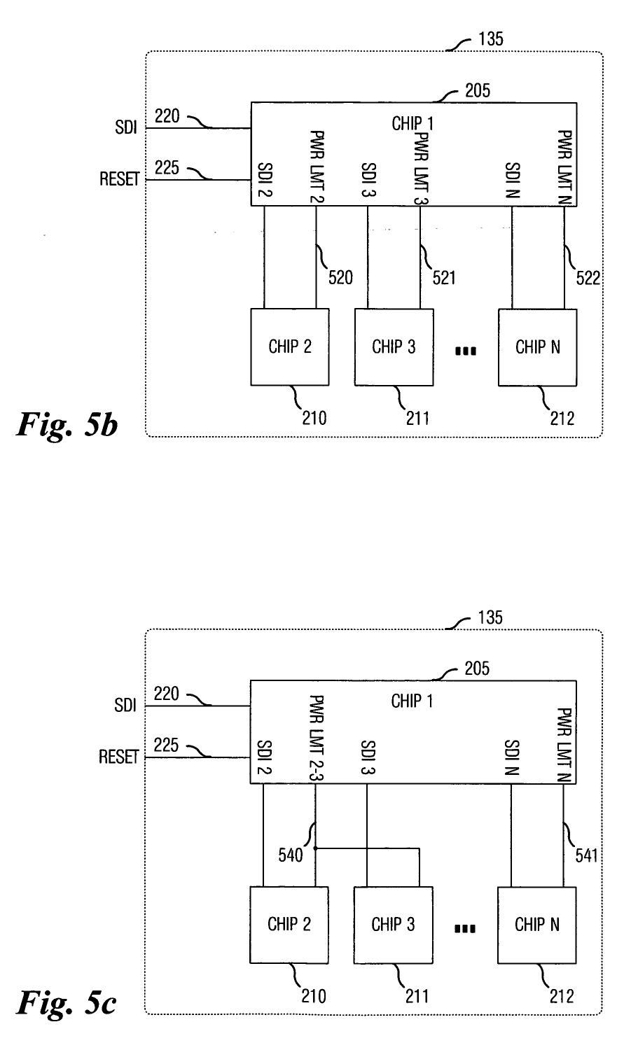

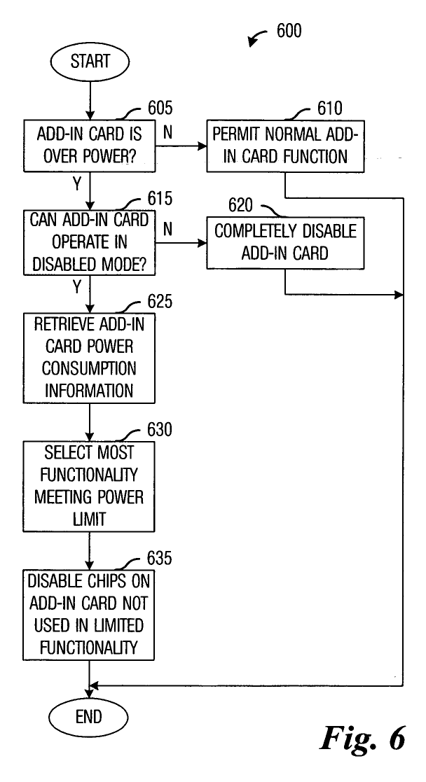

With reference now to FIGS. 5a through 5c, there are shown diagrams illustrating exemplary add-in expansion cards, wherein the add-in cards have the capability to alter their function based upon their power consumption needs and a limit on the amount of power the expansion bus is capable of providing, according to a preferred embodiment of the present invention. The diagrams shown in FIGS. 5a through 5c illustrate a high-level view of the add-in cards 135. The add-in cards 135 shown in FIGS. 5a through 5c can be representative of generic PCI Express add-in cards, which, depending upon implementation can be a video card, sound card, hard disk controller, and so forth. The design of the add-in cards 135 can vary depending upon the actual function of the add-in cards 135, however, the basic high-level architecture will be similar to that shown in FIGS. 5a through 5c.

The diagram shown in FIG. 5a illustrates the add-in card 135 with a common signal line “PWR LMT” 505 that can be used to allow the “Chip 1” 205 to place the other chips in the add-in card 135 into a reset state. When the “Chip 1” 205 determines that the add-in card 135 is in a “subsystem_power_over_condition” state, then the “Chip 1” 205 can assert the “PWR LMT” signal line 505 to place the other chips in the add-in card 135 into a reset state to reduce the power consumption of the add-in card 135. Note that since each of the other chips in the add-in card 135 is coupled to the “PWR LMT” signal line 505, all of the other chips in the add-in card 135 are placed into the reset state. The “Chip 1” 205 can also assert the “PWR LMT” signal line 505 when it detects an asserted reset signal line 225.

The diagram shown in FIG. 5b illustrates the add-in card 135 with separate signal line “PWR LMT” for each of the other chips in the add-in card 135. For example, “Chip 2” 210 can be coupled to the “Chip 1” 205 via a “PWR LMT 2” signal line 520, while a “PWR LMT 3” signal line 521 and a “PWR LMT N” signal line 522 couple “Chip 3” 211 and “Chip N” 212 to the “Chip 1” 205, respectively. The use of separate “PWR LMT” signal lines to each of the other chips in the add-in card 135 can permit the “Chip 1” 205 to reduce the power consumption of the add-in card 135 by putting individual chips into the reset state. This can allow for the add-in card 135 to continue to operate in a limited fashion if the expansion bus slot cannot provide sufficient power rather than preventing the add-in card from operating in its entirety.

The diagram shown in FIG. 5c illustrates the add-in card 135 with individual and grouped signal line “PWR LMT” for the other chips in the add-in card 135. As discussed previously, it may be possible to deactivate certain functionality in the add-in card 135 while permitting other functionality to continue operation and still meet the power consumption constraints required by the expansion bus slot. For some functions of the add-in card 135, the placement of a single chip into the reset state is sufficient to deactivate the function while for other functions, multiple chips need to be placed into the reset state. Therefore, it is possible to group the “PWR LMT” signal lines based upon functions. For example, in the diagram shown in FIG. 5c, a single “PWR LMT 2-3” signal line 540 is coupled to “Chip 2” 210 and “Chip 3” 211 while a single “PWR LMT N” signal line 541 is coupled to the “Chip N” 212. Therefore, if the “PWR LMT 2-3” signal line 540 is asserted, then “Chip 2” 210 and “Chip 3” 211 will be placed into the reset state while if the “PWR LMT N” signal line 541 is asserted, only the “Chip N” 212 will be placed into the reset state.

According to another preferred embodiment of the present invention, the other chips in the add-in card 135 may be integrated into a single chip. Therefore, the add-in card 135 may be made up of the “Chip 1” 205 and a functionally integrated chip (not shown) that incorporates all of the functionality of the other chips in the add-in card 135, such as “Chip 2” 210, “Chip 3” 211, and “Chip N” 212, for example. The functionally integrated chip can be internally partitioned so that clock signals, reset signals, data signals, and so forth can be provided by the “Chip 1” 205. This internal partitioning can also enable the “Chip 1” 205 to maintain its ability to disable the operation of individual partitions (or groups of partitions) of the functionally integrated chip to reduce the power consumption of the add-in card 135. The functionally integrated chip can be fabricated onto a single semiconductor die or it may be formed by using multi-chip module fabrication techniques. The integration of multiple chips into a single multifunction chip is beyond the scope of the present invention and will not be discussed further.

With reference now to FIG. 6, there is shown a flow diagram illustrating an algorithm 600 for regulating the power consumption of an add-in card based on a maximum power provided by an expansion bus slot, according to a preferred embodiment of the present invention. According to a preferred embodiment of the present invention, the algorithm 600 can execute on a controller of an add-in card that is responsible for the operation of the add-in card, such as “Chip 1” 205 (FIG. 2). Alternatively, the algorithm 600 can execute on a general purpose microprocessor, special purpose microprocessor, a custom designed integrated circuit, or so forth.

The controller can begin the execution of the algorithm 600 after the controller has received a message containing a power limit of the expansion bus slot (block 320 (FIG. 3)) and has retrieved power consumption information about the add-in card (block 315 (FIG. 3)). After retrieving the power consumption information regarding the add-in card and receiving the message with the power limit of the expansion bus slot, the controller can determine if the add-in card is over power, i.e., if the add-in card requires more power than the expansion bus slot is capable of providing (block 605). If the add-in card is not over power, then the controller can permit the add-in card to operate in a normal fashion (block 610) and the algorithm 600 can terminate.

If the add-in card is over power, then the controller can check to determine if the add-in card is capable of operating in a disabled mode (block 615). Operation in a disable mode may entail the disabling of certain functions of the add-in card to reduce the overall power consumption of the add-in card. Certain add-in cards may not be able to operate in a disabled mode. Furthermore, certain functions implemented do not lend themselves to operating in a disabled mode. If the add-in card cannot operate in a disabled mode, then the controller must completely disable the add-in card (block 620) and the algorithm 600 can terminate.

If the add-in card can operate in a disabled mode, then the controller can retrieve power consumption information for the add-in card with various functionality disabled (block 625). This information can be provided by the manufacturer of the add-in card and can be stored in a memory, potentially, along with the overall power requirements of the add-in card. As an example, the power consumption information may be listed in tabular form, starting with maximum power consumption and full functionality down to minimum power consumption and minimal functionality. The controller can then select the most functionality that meets the power limit of the expansion bus slot (block 630). The information may also include which of the integrated circuits on the add-in card the controller may need to disable (place into a reset state, shut down the clock signal, disable output transmission, and so forth) to disable the desired function(s). Note that the selection of the function to be disabled can also be based upon a priority set for the function. For example, if the disabling of one of two functions yields similar power savings, then the decision can be based upon a set priority assigned to the two functions, with the lower priority function being selected to be disabled. The priority information can also be included in the power consumption information. The controller can then disable the specific integrated circuits on the add-in card (block 635) and the algorithm 600 can terminate.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for reconciling an add-in card's power requirements with a power limited expansion bus, the method comprising:
retrieving power consumption information for the add-in card;
receiving power limit information for the expansion bus;
determining if the add-in card is over power; and
reducing the add-in card's power consumption if the add-in card is over power.

2. The method of claim 1, wherein the power consumption information for the add-in card is stored in a memory location on the add-in card.

3. The method of claim 1, wherein the power limit information is provided by a software application executing on a computer containing the expansion bus.

4. The method of claim 3, wherein the method executes on a controller located on the add-in card, and wherein a message containing the power limit information is provided to the controller.

5. The method of claim 1, wherein the determining comprises comparing the power consumption information with the power limit information.

6. The method of claim 1, wherein the reducing
comprises asserting an interrupt; and
executing an interrupt service routine to put integrated circuits in the add-in card into a low power state.

7. The method of claim 1, wherein the reducing can be realized by one or more of the following techniques: disabling a clock signal to integrated circuits in the add-in card, disabling output transmissions between integrated circuits in the add-in card, placing integrated circuits in the add-in card into a reset state, and asserting an interrupt to trigger the placement of the integrated circuits in add-in card into a low power state.

8. The method of claim 1, wherein the reducing comprises reducing the power consumption of a subset of integrated circuits in the add-in card.

9. The method of claim 8, wherein specific functionality of the add-in card can be disabled, and wherein the subset of integrated circuits is selected based upon an amount of power reduction desired and specific functionality to be disabled.

10. The method of claim 8, wherein the power consumption can be realized by one or more of the following techniques: disabling a clock signal to the subset of integrated circuits, disabling output transmissions between integrated circuits in the subset of integrated circuits, placing integrated circuits in the subset of integrated circuits into a reset state, and asserting an interrupt to trigger the placement of the integrated circuits in the subset of integrated circuits into a low power state.

11. A method for reducing power consumption in an add-in card, the method comprising:
determining if the add-in card is over power; and
reducing power consumption in a subset of integrated circuits in the add-in card if the add-in card is over power, wherein the subset of integrated circuits is selected based upon a function of the add-in card selected for disablement.

12. The method of claim 11, wherein the determining comprises:
retrieving power consumption information for the add-in card;
receiving power limit information for an expansion bus; and
comparing the power consumption information with the power limit information.

13. The method of claim 11, wherein the function selected for disablement is selected based upon an amount of power saved by disabling the selected function.

14. The method of claim 13, wherein the function selected for disablement is also selected based upon a priority assigned to the function.

15. An add-in card comprising:
a controller coupled to an expansion bus in a computer, the controller being configured to regulate the operation of the add-in card;
a plurality of integrated circuits coupled to the controller, the plurality of integrated circuits being configured to perform an intended function of the add-in card, wherein each integrated circuit is coupled to the controller by a power limit signal line that is used to disable the operation of the integrated circuit to reduce power consumption in the add-in card.

16. The add-in card of claim 15, wherein there are subsets of integrated circuits in the plurality of integrated circuits, wherein each subset of integrated circuits operate together to perform a function, and wherein each integrated circuit in a subset of integrated circuits is coupled to a single power limit signal line.

17. The add-in card of claim 15, wherein the integrated circuits are placed into a reset state to reduce power consumption.

18. The add-in card of claim 15, wherein the controller reduces the power consumption of the add-in card when it determines that the add-in card consumes more power than the expansion bus is capable of providing.

19. The add-in card of claim 18, wherein the controller determines that the add-in card consumes more power than the expansion bus is capable of providing by comparing information regarding the power consumption of the add-in card and the power limit of the expansion bus.

20. The add-in card of claim 15, wherein the plurality of integrated circuits are integrated onto a single module, and wherein the controller is capable of regulating the operation of each integrated circuit located on the module.
